(19) United States
(12) Patent Application Publication
(10) Pub. No.: US 2008/0186367 A1
(43) Pub. Date: Aug. 7, 2008

(54) INK TANK HAVING INTEGRATED RFID TAG

(75) Inventors: Christopher Alan Adkins, Lexington, KY (US); Stephen Porter Bush, Richmond, KY (US); Johnnie Coffey, Winchester, KY (US); John Conway, Louisville, KY (US); Paul William Dryer, Lexington, KY (US); Gina Marie Johns, Nicholasville, KY (US); Christopher Elliot Lingle, Lexington, KY (US); Ganesh Vinayak Phatak, Lexington, KY (US); William Bruce Rose, Lexington, KY (US); Jason Todd Vanderpool, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/691,091

(22) Filed: Mar. 26, 2007

Related U.S. Application Data
(63) Continuation of application No. 11/671,774, filed on Feb. 6, 2007.

(51) Int. Cl. B41J 2/175; B65D 25/00; G08B 13/14

(52) U.S. Cl. 347/86; 220/694; 340/572.8

(57) ABSTRACT

An ink tank includes a reservoir body for containing an ink supply. The reservoir body has a top opening. A top cover is attached to the reservoir body to close the top opening. The top cover has an outer surface. The top cover is formed from a molded material. An RFID tag is integrated into the top cover by one of insert molding the RFID tag in the top cover when the top cover is molded or securing the RFID tag in a recessed region of the top cover.

### BACKGROUND OF THE INVENTION

1. Field of the Invention

The present invention relates to ink jet imaging, and, more particularly, to an ink tank having an integrated radio frequency identification (RFID) tag.

2. Description of the Related Art

A typical ink jet printhead cartridge has an ink tank to which a printhead chip is mounted. A memory may be integrated into the printhead chip. Removing the printhead chip from the ink tank, and making the printhead chip a permanent or semi-permanent part of the printer leaves the ink tank without memory. This reduces the overall functionality of the ink tank.

Radio frequency identification (RFID) refers to a technology that uses memory and electromagnetic waves to identify an object. An RFID tag includes an RFID chip forming a transponder/memory and an antenna connected to the RFID chip. Identification information is stored in the RFID chip. The antenna enables the RFID chip to transmit the identification information to an RFID reader. The RFID reader converts the electromagnetic waves received from the RFID tag into digital information corresponding to the stored identification information.

### SUMMARY OF THE INVENTION

The present invention provides an ink tank having an integrated radio frequency identification (RFID) tag.

The invention, in one form thereof, is directed to an ink tank. The ink tank includes a reservoir body for containing an ink supply. The reservoir body has a top opening. A top cover is attached to the reservoir body to close the top opening. The top cover is formed from a molded material. An RFID tag is insert molded in the top cover when the top cover is molded.

The invention, in another form thereof, is directed to an ink tank. The ink tank includes a reservoir body for containing an ink supply. The reservoir body has a top opening. A top cover is attached to the reservoir body to close the top opening. The top cover has an outer surface and a recessed region having a floor lower than the outer surface. An RFID tag is secured in the recessed region of the top cover.

The invention, in another form thereof, is directed to an ink tank. The ink tank includes a reservoir body for containing an ink supply. The reservoir body has a top opening. A top cover is attached to the reservoir body to close the top opening. The top cover has an outer surface. The top cover is formed from a molded material. An RFID tag is integrated into the top cover by one of insert molding the RFID tag in the top cover when the top cover is molded or securing the RFID tag in a recessed region of the top cover with the RFID tag being lower than the outer surface.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system, configured in accordance with an embodiment of the present invention.

FIG. 2 is a partial perspective diagrammatic view of an ink tank and cover of the imaging system of FIG. 1, having an RFID tag mounted to the top cover of the ink tank, and an RFID reader antenna mounted to the cover and in communication with an RFID reader.

FIG. 3 is a diagrammatic depiction of the RFID tag shown in FIG. 2.

FIG. 4 is a perspective view of the ink tank of FIG. 2, with the top cover shown in cross-section to expose the RFID tag.

FIG. 5 is another embodiment of an ink tank with an RFID tag mounted in a recessed region of the top cover of the ink tank.

FIG. 6 is another embodiment of an ink tank with an RFID tag mounted in a recessed region of the top cover of the ink tank using a thermal upset swaging process.

FIG. 7 is another embodiment of an ink tank with an RFID tag mounted in a recessed region of the top cover of the ink tank by deforming perimetrical features using a thermal upset swaging process.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

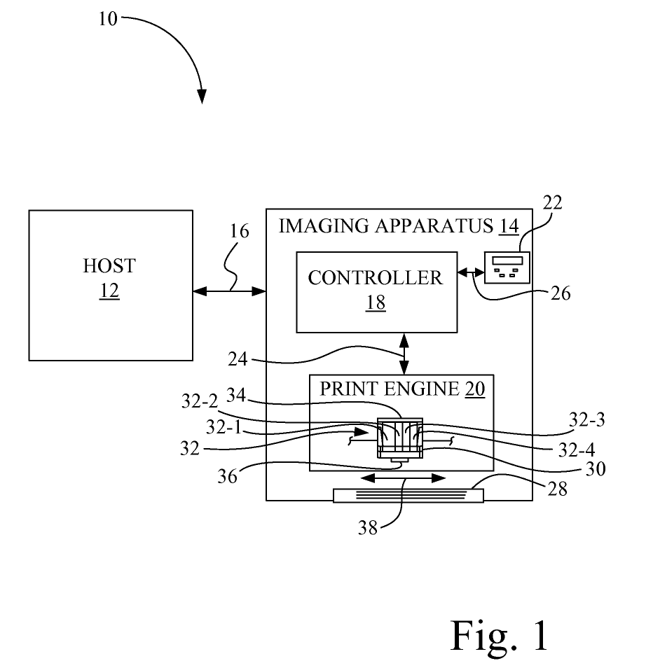

Referring to FIG. 1, there is shown a diagrammatic depiction of an imaging system 10. Imaging system 10 may include a host 12 and an imaging apparatus 14. Imaging apparatus 14 communicates with host 12 via a communications link 16. Communications link 16 may be established by a direct cable connection, wireless connection or by a network connection such as for example an Ethernet local area network (LAN).

Alternatively, imaging apparatus 14 may be a standalone unit that is not communicatively linked to a host, such as host 12. For example, imaging apparatus 14 may take the form of an all-in-one, i.e., multifunction, machine that includes standalone copying and facsimile capabilities, in addition to optionally serving as a printer when attached to a host, such as host 12.

Host 12 may be, for example, a personal computer including an input/output (I/O) device, such as keyboard and display monitor. Host 12 further includes a processor, input/output (I/O) interfaces, memory, such as RAM, ROM, NVRAM, and a mass data storage device, such as a hard drive, CD-ROM and/or DVD units. During operation, host 12 may include in its memory a software program including program instructions that function as an imaging driver, e.g., printer driver software, for imaging apparatus 14. Alternatively, the imaging driver may be incorporated, in whole or in part, in imaging apparatus 14.

In the embodiment of FIG. 1, imaging apparatus 14 includes, for example, a controller 18, a print engine 20 and a user interface 22. The imaging driver facilitates communication between imaging apparatus 14 and host 12, and may provide formatted print data to imaging apparatus 14, and more particularly, to print engine 20. Alternatively, however, all or a portion of the imaging driver may be located in controller 18 of imaging apparatus 14. For example, where imaging apparatus 14 is a multifunction machine having standalone capabilities, controller 18 of imaging apparatus 14 may include the imaging driver configured to support a copying function, and/or a fax-print function, and may be further configured to support a printer function.

Controller 18 includes a processor unit and associated memory, and may be formed as an Application Specific Integrated Circuit (ASIC). Controller 18 communicates with print engine 20 via a communications link 24. Controller 18 communicates with user interface 22 via a communications link 26. Communications links 24 and 26 may be established, for example, by using standard electrical cabling or bus structures, or by wireless connection.

Print engine 20 may be, for example, an ink jet print engine configured for forming an image on a sheet of print media 28, such as a sheet of paper, transparency or fabric. Print engine 20 may include, for example, a reciprocating printhead carrier 30. Printhead carrier 30 is mechanically and electrically configured to mount and carry at least one ink tank 32, and in the present embodiment includes ink tanks 32-1, 32-2, 32-3 and 32-4.

A cover 34 of imaging apparatus 14 is located above and extends over ink tanks 32-1, 32-2, 32-3 and 32-4. Cover 34 may be, for example, configured for latching a respective ink tank 32 to printhead carrier 30, or may be configured as part of an outer or intermediate case of imaging apparatus 14.

During operation, each ink tank 32 is in fluid communication with a corresponding ink jet micro-fluid ejection device 36, e.g., an ink jet printhead. Those skilled in the art will recognize that each ink tank 32 and ink jet micro-fluid ejection device 36 may be formed as separable components, in which case micro-fluid ejection device 36 may include a separate ink jet nozzle array corresponding to each color of ink of ink tanks 32-1, 32-2, 32-3 and 32-4. Alternatively, each ink tank 32 and ink jet micro-fluid ejection device 36 may be formed as an integrated unit, e.g., as an ink jet printhead cartridge.

Printhead carrier 30 transports each ink tank 32, and in turn each ink jet micro-fluid ejection device 36, in a reciprocating manner in a bi-directional main scan direction, i.e., axis, 38 over an image surface of the sheet of print media 28 during a printing operation. Each of ink tanks 32-1, 32-2, 32-3 and 32-4 may contain a different color of ink, e.g., black, cyan, magenta, and yellow inks, respectively.

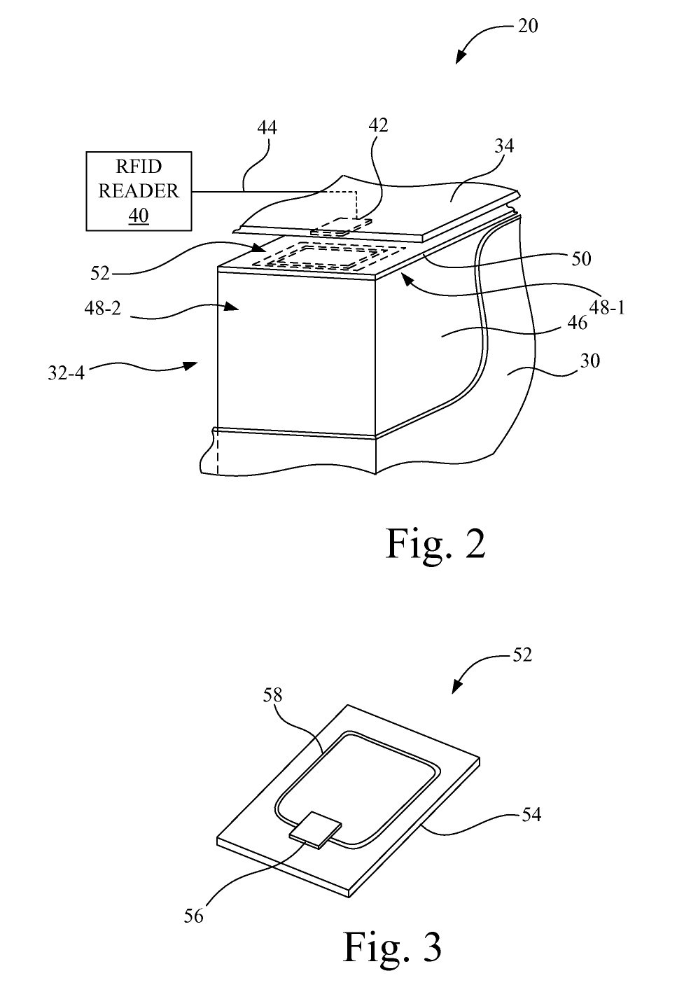

As shown schematically in FIG. 2, print engine 20 of imaging apparatus 14 further includes a radio frequency identification (RFID) reader 40 and an RFID reader antenna 42. RFID reader antenna 42 may be mounted to cover 34 and positioned above and over a respective ink tank 32. RFID reader 40 is communicatively coupled to RFID reader antenna 42 via a communications link, e.g., electrical conductor, 44. Alternatively, RFID reader antenna 42 may be formed integral with RFID reader 40 in the same circuit assembly.

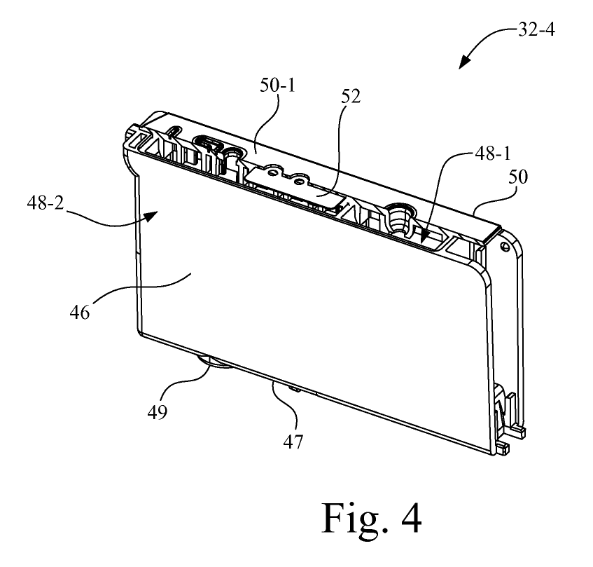

Each ink tank 32, e.g., ink tank 32-4 in the example of FIGS. 2 and 4, includes a reservoir body 46 for containing an ink supply. Reservoir body 46 has a top opening 48-1 formed at a top portion 48-2 of reservoir body 46. A top cover 50 is attached to reservoir body 46, e.g., to form a hermetic seal, at top portion 48-2 to close top opening 48-1, thereby containing the ink supply. An RFID tag 52 is mounted to top cover 50. Top cover 50 has an outer surface 50-1.

As shown schematically in FIG. 3, RFID tag 52 includes a substrate 54, an RFID chip 56 and an antenna 58. Substrate 54 may have dimensions, for example, of about one centimeter wide and two centimeters long. RFID chip 56 forms a transponder, as is known in the art, and includes a readable memory, which in some embodiments may also be writable. Antenna 58 may be formed on substrate 54, e.g., by etching a metallized surface of substrate 54. RFID chip 56 is mounted to substrate 54, e.g., by using an adhesive, and antenna 58 is electrically coupled to RFID chip 56, e.g., by wire bonding, solder, or electrically conductive adhesive. RFID chip 56 may be sealed from contamination, external electrical contact, etc., by applying an epoxy coating over RFID chip 56. If desired, the epoxy coating may be extended over antenna 58 as well.

During operation, RFID reader 40 sends electromagnetic waves via reader antenna 42, which are directed to antenna 58 of RFID tag 52. Antenna 58 of RFID tag 52 is tuned to receive these electromagnetic waves. RFID chip 56 of RFID tag 52 is powered from the electromagnetic field associated with the electromagnetic waves sent by RFID reader 40. RFID chip 56 then generates an electromagnetic signal modulated with information stored on RFID chip 56, and sends the electromagnetic signal back to RFID reader 40. In turn, RFID reader 40 converts the received electromagnetic signal into digital data corresponding to the information stored in RFID chip 56, and forwards information to, for example, controller 18 for further processing or action. The information stored in the memory of RFID chip 56 may include, for example, ink tank identification information and operational information, including a gas gage, color information, encoded ink properties for optimizing printouts, geographic information, OEM identification, and manufacturing data.

In the exemplary embodiment described above with respect to FIGS. 1-4, each top cover 50 of ink tanks 32 is formed from a molded material, with RFID tag 52 being insert molded into top cover 50 when top cover 50 is molded/cast. Insert molding techniques are well known in the art, and for brevity will not be discussed in detail here. In the present embodiment, the insert molding of RFID tag 52 in top cover 50 provides a total encapsulation of RFID tag 52 by the molded material forming top cover 50, which in turn protects RFID tag 52 from, for example, external electrical contact, external forces, contamination, etc. However, it is contemplated that in other embodiments, RFID tag 52 may be less than totally encapsulated, if desired.

The material composition of RFID tag 52, e.g., substrate 54, is selected to withstand a molding temperature of the molded material forming top cover 50, as set forth in the Table 1 below. As can be seen from Table 1 below, top cover 50 may be formed, for example, from a thermoplastic material or a thermo-set material, and may be formed from one of a transparent material and an opaque material.

For convenience, Table 1 in some cases uses acronyms rather than the full chemical name for the material. A table of acronyms with the full chemical names for the material follows thereafter in Table 2.

TABLE 1
Tag Materials and Corresponding Ink Tank Materials

| | | Degradation | | |
|---|---|---|---|---|
| | RFID | Temperature by Tag | Ink | Processing Temperature of Ink |
| | Tag | Material in degrees | Tank | Tank Material in degrees F. |
| Group | Material | Fahrenheit (F.) | Material | (Melting point temperature) |
| 1 | FR-4 | 660 | ABS | 350–440 |
| | PPO | 650 | HIPS | 370 |
| | | | PS | 410 |
| | | | ACETAL | 350–400 |
| 2 | EPOXY | 680 | ASA | 450 |
| | | | NYLON | 480 |
| | | | HDPE | 400–450 |
| | | | PP | 480 |
| 3 | POLYIMIDE | 730 | LCP | 550–600 |
| | | | PC | 500–570 |
| | | | LDPE | 450–610 |

TABLE 2
Definitions of Acronyms used in Table 1

| ACRONYM | CHEMICAL NAME |
|---|---|
| FR-4 | Flame Resistance 4; Fiberglass Reinforced |
| | Epoxy Resin |
| PPO | Polyphenylene Oxide |
| ABS | Acrylonitrile Butadiene Styrene |
| HIPS | High Impact Polystyrene |
| PS | Polystyrene |
| ASA | Acrylic Styrene Acrylonitrile |
| NYLON | Polyamide |
| HDPE | High Density Polyethylene |
| PP | Polypropylene |
| LCP | Liquid Crystal Polymer |
| PC | Polycarbonate |
| LDPE | Low Desisity Polyethylene |

The groups 1, 2 and 3 are identified for convenience as exemplary combinations of RFID tag materials and corresponding ink tank materials.

As an example, an ink tank material, such as polypropylene, may be molded at 230 degrees Celsius (C.) (446 degrees Fahrenheit (F.). RFID tag materials may be specified to have higher withstanding temperatures. For instance, Delo-Katiobond 4670 available from Delo Industrial Adhesives is an ultraviolet (UV) cured encapsulant with a short time use temperature specification of 250 degrees C. (482 degrees F.). This can hold the wire-bonded RFID chip 56 to substrate 54 such as fiberglass with epoxy adhesive MCHT, which has a 3 minute temperature specification of 290° C. (554 degrees F.).

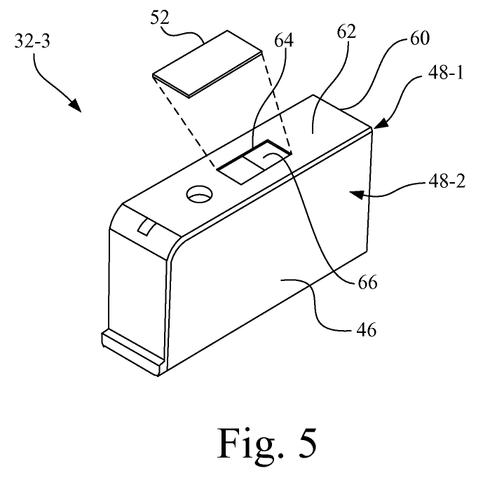

FIG. 5 is another embodiment of an ink tank 32 containing an ink supply, and in this example will be identified as ink tank 32-3. Ink tank 32-3 includes reservoir body 46 having top opening 48-1 formed at top portion 48-2. A top cover 60 is attached to reservoir body 46, e.g., to form a hermetic seal, at top portion 48-2 to close top opening 48-1, thereby containing the ink supply. Top cover 60 may be formed (e.g., molded), for example, from a thermoplastic material or a thermo-set material, and may be formed from one of a transparent material and an opaque material. Top cover 60 has an outer, i.e., top, surface 62. A recessed region 64 is formed in top cover 60 to extend below outer surface 62. Recessed region 64 has a floor 66. Floor 66 is lower than outer surface 62. Recessed region 64 is sized to receive RFID tag 52. RFID tag 52 may be attached to floor 66 of top cover 50 in recessed region 64, e.g., by an adhesive, and sealed over by epoxy and/or a label, if desired. The adhesive may be dispensed, for example, by automated application, using a pump and syringe apparatus. In one embodiment, the adhesive is UV curable adhesive, which provides a quick cure that can typically be localized to the adhesive without damaging the surrounding plastic region of ink tank 32-3.

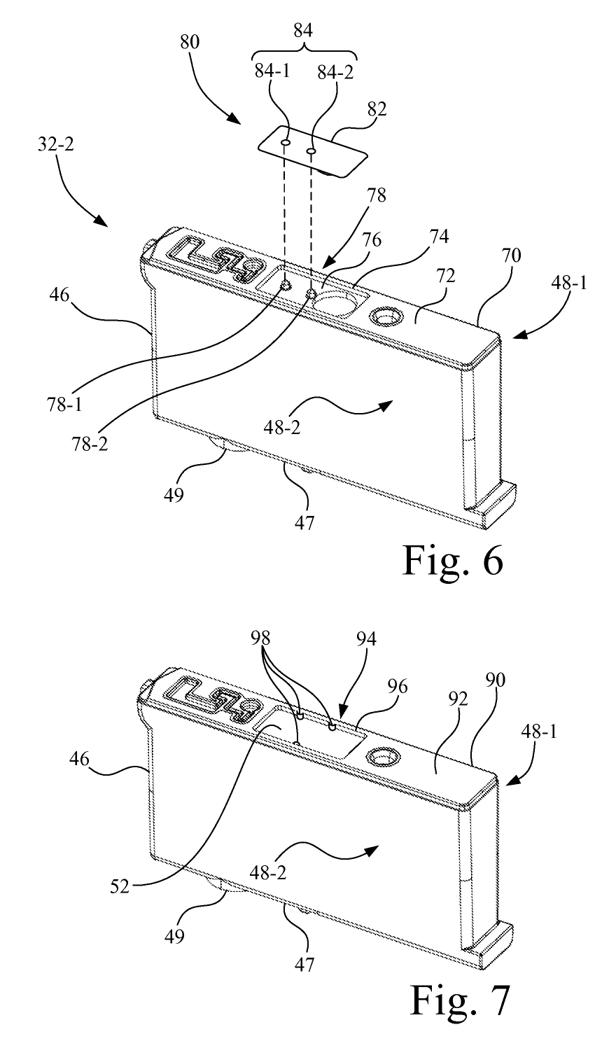

FIG. 6 is another embodiment of an ink tank 32 containing an ink supply, and in this example will be identified as ink tank 32-2. Ink tank 32-2 includes reservoir body 46 having top opening 48-1 formed at top portion 48-2. A top cover 70 is attached to reservoir body 46, e.g., to form a hermetic seal, at top portion 48-2 to close top opening 48-1, thereby containing the ink supply. Top cover 70 may be formed (e.g., molded), for example, from a thermoplastic material or a thermo-set material, and may be formed from one of a transparent material and an opaque material. Top cover 70 has an outer, i.e., top, surface 72. A recessed region 74 is formed in top cover 70 to extend below outer surface 72. Recessed region 74 has a floor 76. Floor 76 is lower than outer surface 72. Extending vertically away from floor 76 is a plurality of pins 78, individually identified as pins 78-1 and 78-2. Recessed region 74 is sized to receive an RFID tag 80.

RFID tag 80 is similar to RFID tag 52 described above, but in addition includes a substrate 82 having a plurality of holes 84, individually identified as holes 84-1 and 84-2, which are located to correspond to the pin pattern of pins 78. RFID tag 80 may be positioned in recessed region 74 with holes 84-1 and 84-2 receiving pins 78-1 and 78-2, respectively. Then, using a thermal upset swaging (heat stake) process, RFID tag 80 is attached to floor 76 of top cover 70 by melting the ends of pins 78-1 and 78-2 over holes 84-1, 84-2, such the distal ends of pins 78-1 and 78-2 are enlarged so as to mechanically lock RFID tag 80 into position on top cover 70. The depth of recessed region 74 may be selected such that RFID tag 80 is positioned lower than outer surface 72, and RFID tag 80 may be sealed with an epoxy.

Those skilled in the art will recognize these heat stake features may take on a multitude of embodiments, the optimum depending on factors such as the RFID tag and top cover material properties, shape/size constraints of the top cover and/or RFID tag, manufacturing, shipping, and operating environment conditions, etc.

As an alternative to the embodiment of FIG. 6, the embodiment of FIG. 7 shows a top cover 90 that is attached to reservoir body 46, e.g., to form a hermetic seal, at top portion 48-2 to close top opening 48-1, thereby containing the ink supply. Top cover 90 may be formed (e.g., molded), for example, from a thermoplastic material or a thermo-set material, and may be formed from one of a transparent material and an opaque material. As shown in FIG. 7, top cover 90 has an outer, i.e., top, surface 92. A recessed region 94 is formed in top cover 90 to extend below outer surface 92. Recessed region 94 has a perimeter 96, with features 98 extending inwardly from perimeter 96. The RFID tag, e.g., RFID tag 52, is positioned over a floor in recessed region 94, and features 98 at perimeter 96 are melted by thermal upset swaging process to heat stake the edges of RFID tag 52 to top cover 90. The features 98 may be raised features that are melted down over the edges of RFID tag 52. The depth of recessed region 94 may be selected such that RFID tag 52 is positioned lower than outer surface 92, and RFID tag 52 may be sealed with an epoxy.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An ink tank, comprising:
a reservoir body for containing an ink supply and having an ink outlet port, said reservoir body having a top opening located opposite to said ink outlet port;
a top cover attached to said reservoir body to close said top opening, said top cover being formed from a molded material; and
an RFID tag insert molded in said top cover when said top cover is molded.

2. The ink tank of claim 1, wherein said RFID tag insert molded in said top cover provides a total encapsulation of said RFID tag by said molded material forming said top cover.

3. The ink tank of claim 1, wherein said RFID tag includes:
an RFID chip forming a transponder; and
a substrate having an antenna, wherein said RFID chip is mounted to said substrate and said antenna is electrically coupled to said RFID chip.

4. The ink tank of claim 1, wherein a material composition of said RFID tag is selected to withstand a molding temperature of said molded material forming said top cover.

5. The ink tank of claim 1, wherein said molded material forming said top cover is one of a thermoplastic material and a thermo-set material.

6. The ink tank of claim 1, wherein said molded material forming said top cover is one of transparent and opaque.

7. An ink tank, comprising:
a reservoir body for containing an ink supply and having an ink outlet port, said reservoir body having a top opening located opposite to said ink outlet port;
a top cover attached to said reservoir body to close said top opening, said top cover having an outer surface and a recessed region having a floor lower than said outer surface;
at least one pin extending from said floor of said recessed region of said top cover; and
an RFID tag located in said recessed region of said top cover on said floor, said RFID tag including at least one hole for respectively receiving therethrough said at least one pin,
wherein a distal end of said at least one pin is enlarged to attach said RFID tag to said floor of said top cover.

8. The ink tank of claim 7, wherein said RFID tag includes:
an RFID chip forming a transponder; and
a substrate having an antenna, wherein said RFID chip is mounted to said substrate and said antenna is electrically coupled to said RFID chip, said substrate being attached by a thermal upset swaging process to said floor in said recessed region of said top cover.

9. The ink tank of claim 7, wherein said RFID tag is secured in said recessed region by thermal upset swaging said at least one pin.

10. The ink tank of claim 7, wherein said RFID tag is secured in said recessed region by an adhesive.

11. The ink tank of claim 7, wherein said RFID tag is positioned lower than said outer surface.

12. The ink tank of claim 11, wherein said RFID tag is sealed with an epoxy.

13. The ink tank of claim 7, wherein said molded material forming said top cover is one of transparent and opaque.

14. An ink tank, comprising:
a reservoir body for containing an ink supply and having an ink outlet port, said reservoir body having a top opening located opposite to said ink outlet port;
a top cover attached to said reservoir body to close said top opening, said top cover having an outer surface, said top cover being formed from a molded material; and
an RFID tag integrated into said top cover by one of insert molding said RFID tag in said top cover when said top cover is molded, or by securing said RFID tag in a recessed region of said top cover with said RFID tag being located on a floor of said recessed region, and wherein at least one pin extending from said floor is positioned in said recessed region of said top cover to facilitate heat stake attachment of said RFID tag to said floor of said recessed region of said top cover.

15. The ink tank of claim 14, wherein said RFID tag includes:
an RFID chip forming a transponder; and
a substrate having an antenna, wherein said RFID chip is mounted to said substrate and said antenna is electrically coupled to said RFID chip.
